(19) United States
(12) Patent Application Publication
(10) Pub. No.: US 2014/0353081 A1
(43) Pub. Date: Dec. 4, 2014

(54) SAFETY LIGHT ASSEMBLY FOR A LADDER

(71) Applicants: Valentine C. LINCH, Tehachapi, CA (US); Dennis F. TODD, Lake Oswego, OR (US)

(72) Inventors: Valentine C. LINCH, Tehachapi, CA (US); Dennis F. TODD, Lake Oswego, OR (US)

(21) Appl. No.: 14/271,826

(22) Filed: May 7, 2014

Related U.S. Application Data
(60) Provisional application No. 61/956,317, filed on Jun. 4, 2013.

(51) Int. Cl. E06C 7/00; F21V 33/00; F21V 17/06; F21V 5/04

(52) U.S. Cl. CPC E06C 7/00; E06C 7/003; F21V 5/048; F21V 33/0064; F21V 17/06; F21W 2131/30
USPC 182/18; 362/253

(57) ABSTRACT

The present disclosure relates to a safety light assembly mountable on a ladder to aid firefighters and other emergency personnel in locating the ladder under adverse visibility conditions such as smoke, darkness, and inclement weather. The light assembly preferably comprises a pair of respective housings each mountable upon one of the outwardly side-facing surfaces of the ladder side members at locations adjacent to the upper end of the ladder. The housings contain respective light sources capable of projecting light in respective opposite outwardly side-facing directions from the ladder while also refracting portions of the light laterally away from the respective outwardly side-facing directions.

### CROSS-REFERENCE TO RELATED APPLICATIONS

This application claims the benefit of U.S. Provisional App. No. 61/956,317, filed Jun. 4, 2013.

### BACKGROUND OF THE INVENTION

The present disclosure relates to a safety light assembly to aid firefighters and other emergency personnel in locating a ladder under adverse visibility conditions such as smoke, darkness, and inclement weather. Such personnel often must locate such a ladder urgently for emergency exit from a building or other structure under such adverse conditions. Previous proposed types of safety lights mountable at or near the top of a ladder have been described in U.S. Pat. Nos. 4,766,525 and 8,167,088. However a problem with such previous proposed types of safety lights is that their directions of light transmission are unduly limited by their mounting positions on the ladder. For example, the light assembly shown in U.S. Pat. No. 4,766,525 transmits light principally in a laterally inward direction from one ladder side member toward an opposing ladder side member, enabling the opposing side member to partially block the inwardly transmitted light while no light is transmitted in an outwardly opposite direction. Alternatively, as shown in U.S. Pat. No. 8,167,088, another previous light assembly directs light principally only in a forward direction from the top of a ladder side member, thereby transmitting little or no light toward either side of the ladder where personnel seeking the ladder are likely to approach.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 is a front view of the top portion of a ladder equipped with an exemplary light assembly in accordance with the present invention having a pair of respective opposite outwardly facing light sources each enclosed by a respective housing mounted on each top end of the two ladder side members.

FIG. 2 is a top view of the ladder of FIG. 1.

FIG. 3 is an enlarged outward side view of one of the respective exemplary light source housings of FIG. 1.

FIG. 4 is a detail view of an exemplary light source mounted within the light source housing of FIG. 3.

FIG. 5 is a detail edge view of one exemplary lens and aperture assembly of the light source of FIG. 4.

FIG. 6 is a simplified circuit diagram of an exemplary light source control system usable with the light source of FIG. 4.

### DETAILED DESCRIPTION OF PREFERRED EMBODIMENTS

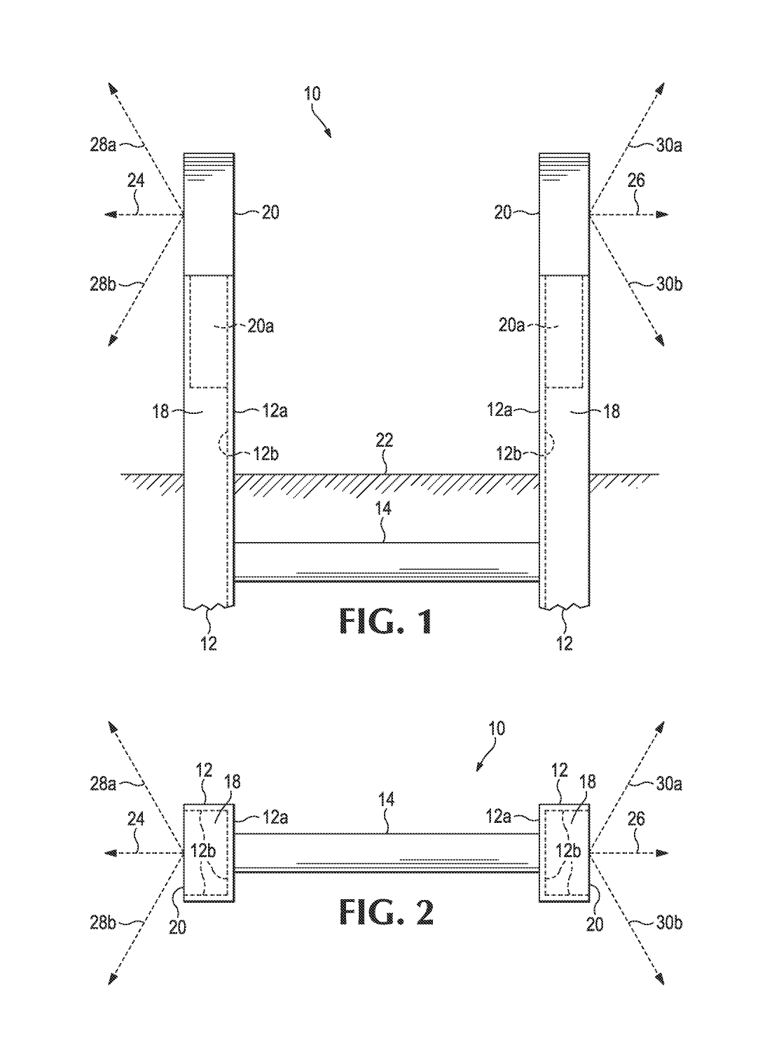

FIGS. 1 and 2 show the top of an exemplary aluminum ladder 10 having a spaced pair of elongate side members 12 with respective inwardly-facing surfaces 12a interconnected by ladder rungs such as 14, and with respective outward surfaces 12b defining elongate depressions 18 facing in respective opposite side-facing directions 24 and 26. The top of each such depression 18 has in the past normally been closed by an upwardly rounded cap member (not shown) having leg portions which fit matingly into the top of each depression 18 so a to eliminate any sharp edges at the top of the ladder which might injure hands or arms or catch loose gloves or garments. Alternatively, other types of ladders are possible, now or in the future, not having such depressions 18 but instead, for example, employing cap members which have downwardly-directed sleeves which slip matingly over the tops of the ladder side members. In any case, such mating cap members are removable from the side members and can be replaced by corresponding other mating members if desired, in accordance with the following disclosure.

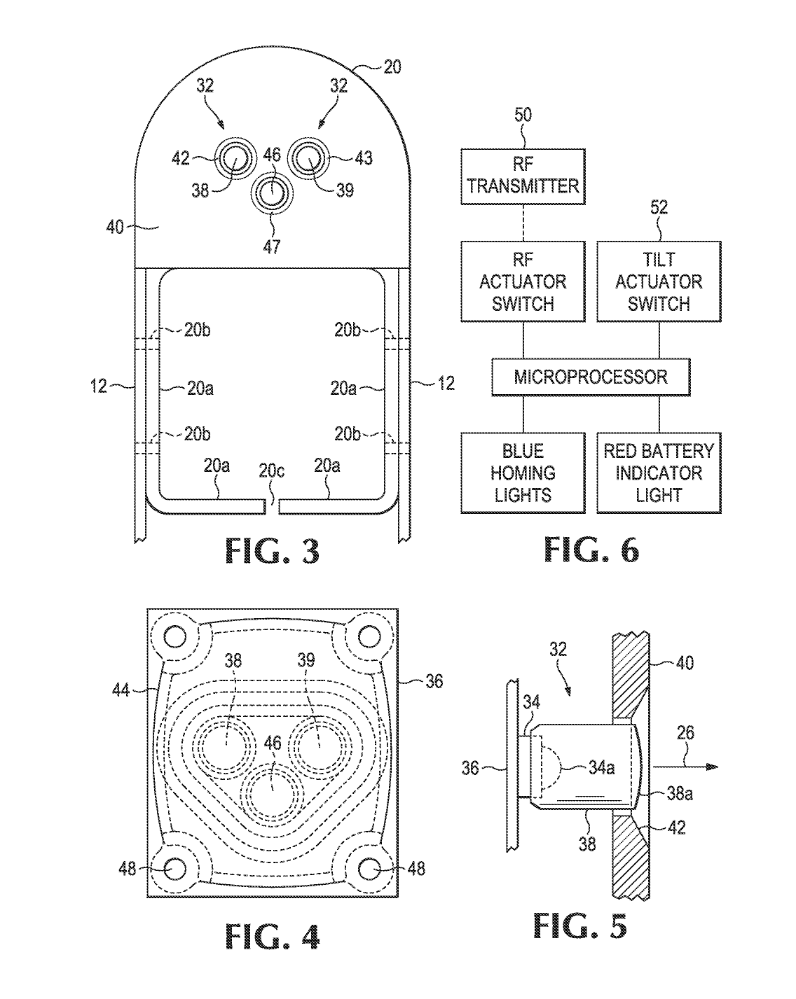

In the exemplary structure of FIGS. 1 and 2, such cap members are replaced by at least one, but preferably two, housings such as 20, each containing at least one light source and a battery power source as well as circuitry to be described hereafter for controlling the light source. With reference also to FIG. 3, mounting of each housing 20 on the ladder is preferably accomplished by insertably mounting a pair of legs 20a of each housing into each depression 18 of the C-shaped side members 12 of the ladder, and fastening each leg 20a in place by any suitable means such as rivets or screws through holes such as 20b as shown in FIG. 3. The legs can be straight or, if desired, L-shaped as shown in FIG. 3 to rigidify the existing C-shaped side members 12 of the ladder particularly in their topmost areas, which have no rung support, against the risks of bending, twisting or collapsing, while also enabling drainage of moisture away from each housing 20 through a gap 20c between the two L-shaped legs 20a.

In FIG. 1, the ladder 10 with the inserted housings 20 is shown leaning against an exposed elevated surface 22, such as a roof, or window or door sill, of a building or other structure where firemen or other emergency personnel may urgently need to access the top of the ladder 10 when it is necessary for them to descend. Under conditions of smoke, darkness, fog, precipitation or other visibility-limiting conditions, and especially in cases of urgency, the top of the ladder could often prove to be difficult to locate when it is not known whether the ladder is located toward the right or left side of the personnel seeking to find it. Previous homing lights as described above, which direct light principally forwardly of the ladder, or in only a single lateral direction partially blocked by the ladder structure, do little to alleviate this problem.

In accordance with the present disclosure, therefore, a significantly more effective solution is accomplished by equipping each housing 20, or any other suitable alternative light source-mounting structure, with a light source capable not only of projecting its light in a respective side-facing direction such as 24 and/or 26 as shown in FIGS. 1 and 2, but also capable of diverging a major portion of its light in multiple angular directions laterally surrounding the respective side-facing direction 24 or 26 so as to project the light in a generally conically expanding shape as exemplified by the broadly spread divergent directions 28a, b and 30a, b shown in FIGS. 1 and 2.

FIG. 5 exemplifies a preferred type of a single light source 32 usable herein. However, although in some applications it may be the only light source within each housing 20, it is preferably used in multiples within each housing 20 as will be explained hereafter. The exemplary light source 32 preferably includes an LED 34 (light-emitting diode) mounted on a circuit board 36 which controls the LED. The LED preferably emits light either at an adjustable pulse rate or at a steady state, as selected and downloaded to a microprocessor (FIG. 6) on the circuit board 36. The light is preferably emitted from the LED through a hemispherical lens 34a and then transported through an integral minimal-loss light pipe portion of a thin-walled diverging lens 38 whose exterior curved lens surface 38a preferably encompasses approximately 60 degrees and is recessed slightly within the outside of an aperture plate 40 of the housing 20, so as to protect the lens 38 from damage. To maximize the lateral divergence of the light emitted from the lens surface 38a, the aperture 42 is beveled (chamfered) laterally outwardly by about 50 degrees or more from the respective side-facing direction such as 26 to maximize the desired expanding light cone. The lens 38 is cored to create a thin-walled divergent lens primarily because, if it were to be a solid piece, the injection molding process would increase the risk of creating bubbles within the lens, thereby causing optic distortion in the lens. The center of the LED 34 is aligned horizontally with the center of the lens 38. The foregoing factors all contribute to minimizing the loss of light intensity between the LED and the ambient conditions outside the lens.

The color of the light emitted by the LED 34 is preferably blue because, when observed, it radiates a soothing psychological effect which is a factor in calming the nerves of personnel at risk. The color blue is a result of the LED radiating at a dominant wavelength of 465 nm. The color blue is also preferable because, in the desired laterally angular directions where maximum light intensity is desired in accordance with this disclosure, the luminous intensity of the blue LED light is greater than that of other lights such as a comparable white LED light. If the LED pulsates, the LED preferably comes on abruptly at high intensity and then dims gradually to zero intensity over the remainder of the cycle.

As mentioned above, multiple light sources similar to light source 32 are preferred within each housing 20. At least two substantially identical light sources, each having a respective LED 34 mounted on the circuit board 36, preferably cooperate with a unitary molded resin lens assembly 44 mounted on the circuit board 36 as shown in FIG. 4. Such two light sources both preferably project blue light through two identical laterally adjacent respective lenses such as 38 and 39 and respective beveled apertures 42 and 43 in the aperture plate 40, as needed to fulfill desired light intensity requirements by combined simultaneous emissions from the multiple light sources. An additional light source, projecting preferably red pulsed light through an identical lens 46 and beveled aperture 47 as shown in FIG. 3, can optionally be used to signal a low battery.

The resin composition of the unitary molded lens assembly 44 may be polycarbonate, or any other suitable lens material. The polycarbonate material is clear and highly resistive to breakage and scratching. When installed in a housing such as 20, the lens material is preferably under no deflective load, and sits directly on the face of the circuit board 36. A trench (not shown) containing an O-ring may be formed in the bottom side of the lens assembly encircling the multiple lenses so that, when the circuit board is attached through screw holes such as 48 in the lens assembly to the housing 20, a seal is created between the lens assembly and the circuit board to minimize light leakage.

FIG. 6 shows an exemplary simplified operating circuit usable in controlling the foregoing light source system. Actuation and deactivation of the system can be by remote control from an RF transmitter 50. No manual control switch on the ladder itself is recommended because it would often be in an awkward position for the user, or would require the user to divert attention from other tasks. The signal from the transmitter could be programmed so as to activate as many or as few light sources as the user wishes, subject to distance limitations of the system.

Alternatively, or in combination with the remote control, actuation and deactivation could be controlled automatically by a tilt sensor switch 52 which activates the system preferably when the ladder is at or beyond a predetermined tilt angle such as 45 degrees regardless of which end of the ladder is lifted. Such tilt sensor switches are shown, for example, in U.S. Pat. No. 7,045,724 or US patent application publication No. 20120325629, which are incorporated herein by reference.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

We claim:

1. A light assembly mountable on a ladder which has a spaced pair of elongate side members with respective inwardly-facing surfaces interconnected by ladder rungs and with respective outwardly side-facing surfaces facing in respective opposite side-facing directions, said light assembly comprising a pair of respective housings each mountable upon a respective one of said outwardly side-facing surfaces at locations adjacent to one end of said ladder, said housings containing separate respective light sources capable, when said housings are so mounted, of projecting light in said respective opposite side-facing directions while also diverging a major portion of their light laterally from said respective opposite side-facing directions.

2. The light assembly of claim 1, each of said housings being so mounted upon a respective one of said outwardly side-facing surfaces.

3. The light assembly of claim 1 wherein said light sources have respective light-diverging lenses capable of refractively diverging said light laterally from one of said respective side-facing directions.

4. The light assembly of claim 1 wherein each of said housings has a respective aperture through which a respective light source can project said light in one of said respective side-facing directions, each said aperture having a perimeter which is beveled laterally outwardly toward said one of said respective side-facing directions.

5. The light assembly of claim 1, further including a respective further light source located adjacent to each of said respective light sources and capable of projecting further light in one of said respective side-facing directions while also diverging said further light laterally from said one of said respective side-facing directions.

6. The light assembly of claim 5 wherein each of said light sources has a respective light-diverging lens for refracting said light laterally away from one of said respective side-facing directions.

7. The light assembly of claim 6 wherein each of said housings has a respective aperture through which a respective light source can project said light in one of said respective side-facing directions, each said aperture having a perimeter which is beveled laterally outwardly toward said one of said respective side-facing directions.

8. The light assembly of claim 1 wherein each of said light sources is selectively controllable to project said light alternatively either as pulsed light or as unpulsed light.

9. The light assembly of claim 1 wherein each of said light sources is selectively activatable from locations remote from said housings.

10. The light assembly of claim 1 wherein each of said light sources is selectively activatable in response to tilting of said ladder to a predetermined tilted attitude.

11. A light source mountable on a ladder having a spaced pair of elongate side members with respective inwardly-facing surfaces interconnected by ladder rungs and with respective outwardly side-facing surfaces facing in respective opposite side-facing directions, said light source being mountable on a respective one of said outwardly side-facing surfaces adjacent to one end of said ladder so as to project its light in one of said respective opposite side-facing directions, said light source also being capable of refracting portions of its light laterally from said one of said respective opposite side-facing directions through a light-diverging lens when said light source is mounted on said respective one of said outwardly side-facing surfaces.

12. The light source of claim 11, said light source being so mounted on said respective one of said outwardly side-facing surfaces.

13. The light source of claim 11 wherein said lens is located within a housing mountable on a respective one of said outwardly side-facing surfaces, said housing having an aperture through which said light source can project said light in one of said respective side-facing directions when so mounted, said aperture having a perimeter which is beveled laterally outwardly toward said one of said respective side-facing directions.

14. The light source of claim 11, further including a respective further light source located adjacent to said light source capable of projecting further light in said one of said respective side-facing directions and having a further light-diverging lens capable of refracting portions of said light laterally from said one of said respective side-facing directions.

15. The light source of claim 14 wherein said further light-diverging lens is located within a housing having respective circular apertures through which each respective light source can project said light in one of said respective side-facing directions, each said aperture having a perimeter which is beveled laterally outwardly toward said one of said respective side-facing directions.

16. The light source of claim 11, said light source being selectively controllable to project said light alternatively either as pulsed light or as unpulsed light.

17. The light source of claim 11 wherein said light source is selectively activatable from locations remote from said light source.

18. The light source of claim 11 wherein said light source is selectively activatable in response to tilting of said ladder to a predetermined tilted attitude.

19. The light source of claim 11 wherein said lens is located within a housing mountable on a respective one of said outwardly side-facing surfaces by fastening of said housing to said side-facing surface by a pair of L-shaped legs insertable into a depression formed by said side-facing surface.
